(19) United States
(12) Patent Application Publication
(10) Pub. No.: US 2008/0091783 A1
(43) Pub. Date: Apr. 17, 2008

(54) METHOD AND APPARATUS FOR REAL-TIME RECEIVING OF MAILS

(75) Inventors: Zhiqiang He, Beijing (CN); Ying Liang, Beijing (CN); Rihui Tian, Beijing (CN); Xingwen Chen, Beijing (CN); Donghai Shi, Beijing (CN); Xiaolin Zhang, Beijing (CN); Zhongqing Li, Beijing (CN)

Correspondence Address: DICKSTEIN SHAPIRO LLP, 1177 AVENUE OF THE AMERICAS (6TH AVENUE), NEW YORK, NY, 10036-2714, US

(73) Assignee: LENOVO (BEIJING) LIMITED, Beijing (CN)

(21) Appl. No.: 11/865,498

(22) Filed: Oct. 1, 2007

(30) Foreign Application Priority Data
Sep. 30, 2006 (CN) 200610159681.1

(51) Int. Cl. G06F 15/16

(52) U.S. Cl. 709/206

(57) ABSTRACT

The present invention provides a method for real-time receiving of mails, comprising: step 1 of a control block controlling a wireless block to receive the mails from a mail server and storing them in a storage block when a computer is in a sleep, suspend or shutdown mode; and step 2 of the mails stored in the storage block being synchronized to a mail program of the computer after the computer is turned on. It is possible to update mails in a real-time manner when the computer is in a sleep, suspend or shutdown mode by the present invention with simple device structure. The present invention also supports mails pushed by the mail server, and has the advantages of time saving, power saving and safety.

### BACKGROUND OF THE INVENTION

1. Field of Invention

The present invention relates to methods for receiving e-mails, more particularly, to a method and an apparatus for real-time receiving of mails when a computer is in a sleep, suspend or shutdown mode.

2. Description of Prior Art

Presently, e-mails have become one of primary business tools. For a company user, there are increasing mails to be handled with. When a user receives mails inside the company, the speed is fast, because those mails are received by a company mail server first, and then are downloaded directly from the company mail server upon being received at the user and thus go through an internal network of the company.

However, for more and more business users who often go out of offices on business, they may not directly access the mail server inside the company when they are outside the company for the sake of security, and thus need to receive mails through external networks. However, mails addressed to those business users are always in large amount. Therefore, for those business users out of offices, there is an urging need for immediate and quick acquiring of mails from the company mail server.

At present, there are mainly two methods by which the users outside the company acquire mails from the company mail server.

1) Method of Computer+VPN (Virtual Private Network)

VPN client software is running first on a computer so as to connect to the company network. Then, mail client software is run so as to connect to the company mail server. The advantage of this method consists in that mails are received from the company mail server in the same manner as they are received inside the company. However, this method suffers from the disadvantage that it takes a long time to download mails due to limited speeds of the external networks. Especially, for enterprise high-levels who have a lot of mails to receive, it takes even longer time to wait for downloading, sometimes an hour, which is unacceptable for those busying business persons.

2) Method of Mobile E-mail

To meet the need for receiving mails from the company server at any time and everywhere, a PushMail service has been raised. PushMail means that e-mails are directly pushed to a mobile terminal by means of the pushing technique. Putting in simple words, a system directly sends a mail just received in a mailbox to the user immediately, unlike a conventional mobile mail system where sending of mails depends on regularly receiving of mails by the mail client or voluntarily checking of the mailbox by the user. Therefore, data on the user terminal are synchronized with those in the designated mailbox all the time.

Now, BlackBerry terminals using the PushMail service are becoming increasingly prosperous, with sales of more than 500 million sets. However, there are the following disadvantages.

a. The PushMail service directs to compact mobile terminals (such as mobile phones or BlackBerry terminals) while not to computer systems.

b. The mobile terminals shall be in a standby state all the time.

c. A corresponding PushMail server shall be deployed in an enterprise, or at the same time a corresponding service must be provided by a provider.

Moreover, to carry out mail receiving when a computer is shut down, there has proposed a technique where a subsystem independent of the computer is used, so that e-mail receiving/sending may be carried out directly when the host computer system is shut down, and functions of converting between mails in voice format and mails in text format may be performed, causing the user to learn the contents of the mails at the quickest time. However, there exist the following disadvantages in this technique.

1. The subsystem in this technique is an independent system basically. The subsystem is capable of displaying and processing mails by itself, corresponding to a full-functional mail receiving and sending device independent from the computer. Therefore, this equals to that relevant parts for receiving and sending mails of the original host system are taken out and combined with a memory, a display and a network controller and the like outside the host system to form a new independent system. Thus, it needs many additional components, and the display and the network controller and the like cannot be shared with the host system, resulting in complex configuration, poor versatility, and especially incapability of being applied to notebook computers mainly characterized in portability.

2. This technique deals with normal mail receiving and sending, while not with PushMail.

3. With this technique, the received mails are directly displayed on the subsystem, and the received mails are stored in the external memory, involving no interactive processing of the mails received by the subsystem with the host system.

### SUMMARY OF THE INVENTION

An object of the present invention is to provide a method and an apparatus for real-time receiving of mails, so as to overcome the problem in the prior art that it is difficult to update mails in a real-time manner when a computer is in a sleep, suspend or shutdown mode, as well as to simplify the device while supporting mails pushed by a server.

In order to achieve the above object, the present invention provides a method for real-time receiving of mails, comprising:

step 1: when a computer is in a sleep, suspend or shutdown mode, a control block controlling a wireless block to receive the mails from a mail server and storing them in a storage block; and

step 2: after the computer is turned on, the mails stored in the storage block being synchronized to a mail program of the computer.

In the above method, the step 1 comprises:

step a: after the computer is in a sleep, suspend or shutdown mode the control block controlling the wireless block to connect to a wireless network;

step b: the control block connecting to the mail server through the wireless network; and

step c: the control block downloading or receiving the mails pushed by the mail server through the wireless network and storing them in the storage block.

In the above method, in the step b, the control block inquires whether there is a new mail for the computer at the mail server by means of polling or by receiving a new mail notification.

In the above method, the step 2 comprises:

step A: after the computer is turned on, a mail synchronizing block of the computer being started;

step B: the mail synchronizing block storing the mails stored in the storage block into a local mailbox corresponding to the mail client of the computer; and

step C: after starting the mail program, the user directly dealing with the mails at the local mailbox.

In order to achieve the above object, the present invention also provides an apparatus for real-time receiving of mails, comprising a control block, a wireless block and a storage block, wherein

the wireless block is configured to connect to a wireless network; and

the control block is configured to control the wireless block, when a computer is in a sleep, suspend or shutdown mode, to receive the mails from a mail server and store them in the storage block, and is configured to synchronize the mails stored in the storage block to a mail program of the computer after the computer is turned on.

In order to achieve the above object, the present invention further provides a computer for real-time receiving of mails, comprising a normal computer system, and further comprising a control block, a wireless block and a storage block powered separately from the computer system, wherein

the wireless block is configured to connect to a wireless network; and

the control block is configured to control the wireless block, when the computer system is in a sleep, suspend or shutdown mode, to receive the mails from a mail server and store them in the storage block, and is configured to synchronize the mails stored in the storage block to a mail client of the computer system after the computer system is turned on.

Preferably, a mail synchronizing block is installed in the computer system for storing the mails stored in the storage block into a local mailbox corresponding to the mail program of the computer system.

Preferably, the mail synchronizing block is set to automatically run upon booting or is manually started by a user.

Preferably, a power supply for supplying power to the control block, the wireless block and the storage block are provided separately from or integrated into a power supply block of the computer system.

The present invention has the following advantages.

1) Time Saving.

The user can see the new mails immediately without waiting when he/she turns on the computer by receiving the mails when the computer is shut down and automatically synchronizing the mails to the user's local mail program when the user turns on the computer. This saves time for the users, improves the efficiency of the users, and provides good user experiences. For business persons with a lot of mails, the effects are especially significant.

2) Power Saving.

The user only needs to put the control block and wireless block (WWAN card) in a standby state rather than start the computer system to update mails.

3) Safety.

When the computer is shut down/sleeping, the received mails are temporarily buffered in the external memory, avoiding frequent operations on the hard disk of the computer, and thus reducing the damage to the hard disk.

### BRIEF DESCRIPTION OF THE DRAWINGS

FIG. 1 is a diagram of a configuration of an apparatus for real-time receiving of mails according to a first embodiment of the present invention;

FIG. 2 is a diagram of a configuration of the apparatus for real-time receiving of mails according to a second embodiment of the present invention;

FIG. 3 is a diagram of the architecture of the software of the present invention;

FIG. 4a is a flow chart illustrating the operation of the present invention when the notebook computer is shut down; and

FIG. 4b is a flow chart illustrating the operation of the present invention when the notebook computer is turned on.

### DETAILED DESCRIPTION OF PREFERRED EMBODIMENTS

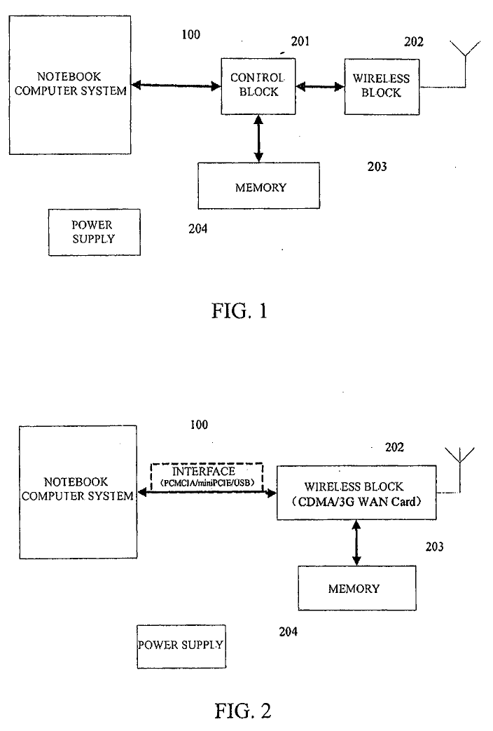

FIG. 1 is a diagram of a configuration of an apparatus for real-time receiving of mails according to a first embodiment of the present invention. As show in the figure, the apparatus for real-time receiving of mails comprises a control block 201, a wireless block 202 and a storage block 203. The control block 201 is also connected to a notebook computer system 100. Among them, the wireless block 202 is provided for connecting to a wireless network; the control block 201 is provided for controlling the wireless block 202 to receive mails for the notebook computer when the notebook computer is in a sleep, suspend or shutdown mode and storing the mails in the storage block 203. After the notebook computer is turned on, the mails stored in the storage block 203 are synchronized to a mail program of the notebook computer. There is also a power supply 204 for separately supplying power to the apparatus for updating mails when the notebook computer is shut down/sleeping. The power supply 204 may be separately provided, or may be incorporated into a power supply block of the notebook.

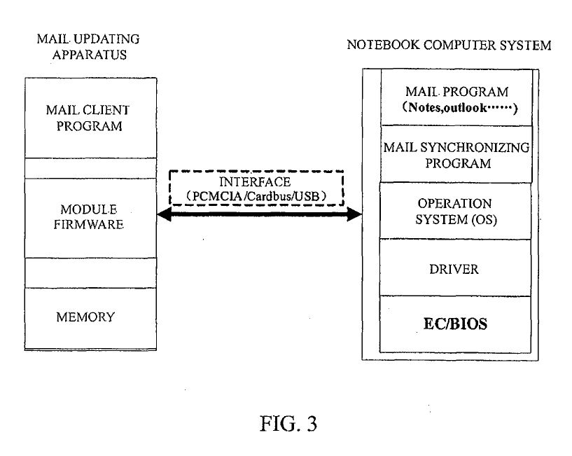

FIG. 2 is a diagram of a configuration of the apparatus for real-time receiving of mails according to a second embodiment of the present invention. As shown in the figure, in this embodiment, the control block is integrated into the wireless block 202, because processors on base-band chips of some wireless blocks suffice to perform functions of the control block.

Next, the components of the hardware of the present invention will be described in detail.

Notebook Computer System 100

It may adopt an existing notebook computer system with a power supply section modified so as to secure that the wireless block, the control block and the storage block are powered when the notebook computer is shut down or is sleeping. The power supply section may be modified as follows. 1) The power management method for the notebook computer system is modified so as to supply power when the notebook computer is shut down or is sleeping; and 2) the power supplying is modified in the hardware so as to support separate supplying.

Wireless Block 202

The wireless block may be a WWAN (Wireless Wide Area Network) card, such as a CDMA1X/3G (WCDMA, CDMA2000, TD-SCDMA) card, among other wireless blocks. The wireless block may access network resources and perform functions of data transfer. The used wireless block may be plug-in or built-in. An interface for the block may be PCMCIA/USB/miniPCIE and the like.

Control Block 201

The control block runs an embedded mail client, which accesses a mail server through the wireless block to download mails, and then stores the mails in a storage unit of the control block. The mail server may be a Lotus Domino, Exchange or mobile e-mail server. The program learns that there is a new mail at the server by means of polling or pushing technique. The control block may be an independent processor, such as a digital signal processor (DSP), a complex programmable logic device (CPLD), a field programmable gate array (FPGA), an application specific integrated circuit (ASIC) and the like, and also may be accomplished by a processor on a base-band chip of the wireless block, such as a MSM6250 base-band chip from QUALCOMM. In the embodiment shown in FIG. 2, the control block is incorporated into the wireless block. In the embodiment shown in FIG. 1, the control block is separated from the wireless block.

Storage Block 203

The storage block is provided mainly for temporarily storing mails received when the notebook computer is shut down or is sleeping. The storage block may be a nonvolatile memory such as a NOR Flash or a NAND Flash. The storage block may be incorporated into the wireless block, either being a separate memory, or being a memory shared with a memory for the software of the wireless block, and also may be a separate memory attached to the notebook computer system.

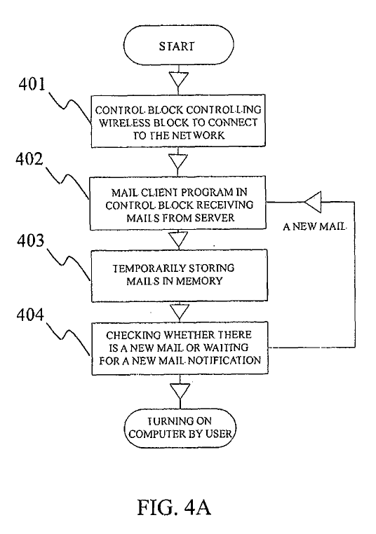

The architecture of the software of the present invention is shown in FIG. 3.

The software involved in the present invention mainly comprises an embedded mail client running on the control block and a mail synchronizing program running on the notebook computer.

Mail Client Program

It downloads mails from the mail server and temporarily stores them in the memory.

Mail-Synchronizing Program

This program is set to run automatically upon booting or be started manually by the user. When the user starts the notebook computer, this program runs automatically or is started manually by the user. After starting, the program synchronizes information about the mails stored in the memory to a local mailbox of the notebook computer, which mailbox may be a Lotus notes, Microsoft outlook mail client program or the like.

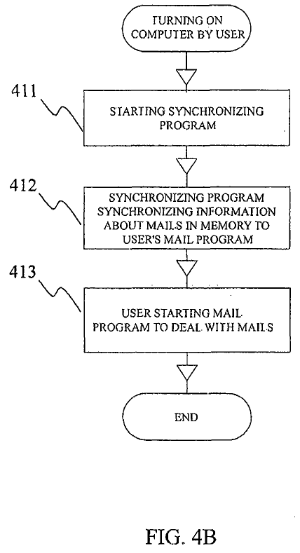

FIG. 4a is a flow chart illustrating the operation of the present invention when the notebook computer is in a sleep, suspend or shutdown mode. As shown in the figure,

when the notebook computer is shut down,
step 401: the client program is running on the control block so that the control block controls the wireless block to connect to the network;
step 402: the client program is run on the control block to download or receive the mails pushed by the PushMail server;
step 403: the mails are temporarily stored in the memory;
step 404: the client program is running on the control block to inquire whether there is a new mail at the server by means of polling or wait for a new mail notification from the server, and if there is a new mail, then the flow returns to step 402;
step 405: the procedure of steps 402, 403 and 404 are repeated until the user turns on the computer or shuts down this function.

Certainly, step 404 of checking mails may be performed before steps 402 and 403, and then the procedure of steps 404, 402 and 403 are repeated until the user turns on the computer or shuts down this function.

FIG. 4b is a flow chart illustrating the operation of the present invention when the notebook computer is turned on. As shown in the figure,

after the notebook computer is turned on,
step 411: the synchronizing program is started;
step 412: the synchronizing program synchronizes the contents of the mails in the memory of the control block to the local mailbox of the user mail program;
step 413: the user starts the mail program to deal with the mails at the local mailbox.

Concerning the above, the present invention is characterized in that:

1) a control block and a wireless block are attached to a notebook computer, and are capable of being separately powered when the notebook computer is in a sleep, suspend or shutdown mode, so that they are powered when the notebook computer is shut down or is sleeping, and the control block controls the wireless block to connect to the network and access the network resources when the notebook computer is shut down, wherein the control block comprises a computing unit and a storage unit;

2) a mail client program is run on the control block so as to receive mails when the notebook computer is shut down and temporarily store them in the storage unit of the control block;

3) a synchronizing program is installed in the notebook computer, and is set to run automatically upon booting or be started manually by the user;

4) after the user turns on the notebook computer, the synchronizing program synchronizes information about the mails in the control block to a user's mail program such as Lotus notes, outlook and the like, and when the user starts the mail program, the mails have already been stored locally.

In view of the above features, it can be seen that the present invention has the following advantages.

1) Time Saving.

The user can see the new mails immediately without waiting when he/she turns on the computer by receiving the mails when the computer is shut down and automatically synchronizing the mails to the user's local mail program when the user turns on the computer. This saves time for the users, improves the efficiency of the users, and provides good user experiences. For business persons with a lot of mails, the effects are especially significant.

2) Power Saving.

For the user's notebook computer, it only needs to put the WAN card in ready rather than start the notebook computer system to update mails.

3) Safety.

When the notebook computer is shut down/sleeping, the received mails are temporarily buffered in the external memory, avoiding frequent operations on the hard disk of the notebook computer, and thus reducing the damage to the hard disk.

Those described above are only embodiments of the present invention. It is to be noted that variations and modifications are possible without departing from the principle of the present invention. These variations and modifications are also in the scope of the present invention.

1. A method for real-time receiving of mails, comprising:
step 1: when a computer is in a sleep, suspend or shutdown mode, a control block controlling a wireless block to receive the mails from a mail server and storing them in a storage block; and
step 2: after the computer is turned on, the mails stored in the storage block being synchronized to a mail program of the computer.

2. The method according to claim 1, characterized in that, the step 1 comprises:
step a: after the computer is shut down, the control block controlling the wireless block to connect to a wireless network;
step b: the control block connecting to the mail server through the wireless network; and
step c: the control block downloading or receiving the mails pushed by the mail server through the wireless network and storing them in the storage block.

3. The method according to claim 2, characterized in that, in the step b, the control block inquires whether there is a new mail for the computer at the mail server by means of polling or by receiving a new mail notification.

4. The method according to claim 1, characterized in that, the step 2 comprises:
A: after the computer is turned on, a mail synchronizing block of the computer being started;
step B: the mail synchronizing block storing the mails stored in the storage block into a local mailbox corresponding to the mail program of the computer; and
step C: after starting the mail program, the user directly dealing with the mails at the local mailbox.

5. An apparatus for real-time receiving of mails, comprising a control block, a wireless block and a storage block, wherein
the wireless block is configured to connect to a wireless network; and
the control block is configured to control the wireless block, when a computer is shut down, to receive the mails from a mail server and store them in the storage block, and is configured to synchronize the mails stored in the storage block to a mail program of the computer after the computer is turned on.

6. A computer for real-time receiving of mails, comprising a control block, a wireless block and a storage block powered separately from the host system, wherein
the wireless block is configured to connect to a wireless network; and
the control block is configured to control the wireless block, when the computer system is shut down, to receive the mails from a mail server and store them in the storage block, and is configured to synchronize the mails stored in the storage block to a mail program of the computer system after the computer system is turned on.

7. The computer according to claim 6, characterized in that, a mail synchronizing block is installed in the computer system for storing the mails stored in the storage block into a local mailbox corresponding to the mail program of the computer system.

8. The computer according to claim 7, characterized in that, the mail synchronizing block is set to automatically run upon booting or be manually started by a user.

9. The computer according to claim 7, characterized in that, a power supply for supplying power to the control block, the wireless block and the storage block are provided separately from or integrated into a power supply block of the computer system.

10. The method according to claim 2, characterized in that, the step 2 comprises:
step A: after the computer is turned on, a mail synchronizing block of the computer being started;
step B: the mail synchronizing block storing the mails stored in the storage block into a local mailbox corresponding to the mail program of the computer; and
step C: after starting the mail program, the user directly dealing with the mails at the local mailbox.
